(19) United States
(12) Patent Application Publication
(10) Pub. No.: US 2005/0277091 A1
(43) Pub. Date: Dec. 15, 2005

(54) Arrangement for a tooth replacement or unit forming part thereof

(76) Inventors: Matts Andersson, Lerum (SE); Izidor Brajnovic, Goteberg (SE); Urban Nilsson, Kungalv (SE)

Correspondence Address: KNOBBE MARTENS OLSON & BEAR LLP, 2040 MAIN STREET, FOURTEENTH FLOOR, IRVINE, CA, 92614, US

(21) Appl. No.: 11/140,516

(22) Filed: May 26, 2005

Related U.S. Application Data
(63) Continuation of application No. PCT/SE03/01799, filed on Nov. 20, 2003.

(30) Foreign Application Priority Data
Nov. 27, 2002 (SE) SE 0203496-5

(51) Int. Cl. A61C 11/00; A61C 13/08

(52) U.S. Cl. 433/213; 433/206

(57) ABSTRACT

An ordering and manufacturing system is used to produce all or part of a tooth replacement from gold. Functions are included for scanning or reading of the treatment situation. Computerized simulating and/or shape-determining functions determine the optimum or desired shape of the tooth replacement. The system is activated for ordering and manufacturing all or part of the tooth replacement. A module system is capable of selecting, from among various manufacturing materials and tools, a manufacturing material in the form of gold and a tool in the form of a casting tool. The module system controls or determines the supply or amount of gold to the casting tool. A dental crown or unit can be made of cast gold. A known ordering and manufacturing system can be used and retain its effective and rapid functions at the same time as another alternative for tooth replacement is presented on the market.

### PRIORITY INFORMATION

This application is a continuation of International Application PCT/SE2003/001799, with an international filing date of Nov. 20, 2003, published in English and which claims priority under 35 U.S.C. § 119 to Swedish Patent Application No. SE 0203496-5, filed Nov. 27, 2002, the entire contents of both of which are expressly incorporated by reference herein.

### BACKGROUND OF THE INVENTION

1. Field of the Invention

The invention relates to tooth replacement, also relates to a tooth replacement or unit as such.

2. Description of the Related Art

It is also already well known per se to use gold and gold alloys in connection with tooth replacements and units. On this point, reference may be made to the prior art. Gold is here intended to also signify gold alloys which can contain varying or different contents of gold.

A highly automated ordering and manufacturing system PROCERA® is described at various places in the patent literature and elsewhere, and in this connection reference may be made inter alia to EP 0490848 and EP 0634150. Other systems with the same aims as the PROCERA® system are also presented in the patent literature and elsewhere.

### SUMMARY OF THE INVENTION

An embodiment of the present invention relates to an automated ordering and manufacturing system for producing a tooth replacement part from gold. The system comprises a measurement device configured to determine a shape of a treatment site. A simulation device is configured to generate a desired shape of the tooth replacement part based, at least in part, upon measurements received from the measurement device. A communications link is configured to receive information to initiate ordering and manufacturing of the tooth replacement part. A module system is configured to, on the basis of a activation signal transmitted by the communications link, of selecting, from a plurality of manufacturing materials and tools. The plurality of manufacturing materials and tools, includes at least a manufacturing material in the form of gold or gold material and a tool in the form of a casting tool. The module system is further configured, on the basis of information supplied to the ordering and manufacturing system through the communications link, to determine an amount of gold material to be supplied to the casting tool.

Another embodiment of the present invention relates to a tooth replacement part that is made at least partially of a gold material.

Another embodiment of the present invention relates to an arrangement using a highly automated ordering and manufacturing system, preferably of the PROCERA® type, to produce all or part of a tooth replacement, for example a dental crown, bridge, etc., or a unit forming part of a tooth replacement, for example a sleeve, outer coating, etc., from gold. The arrangement comprises functions for scanning and/or reading of the treatment situation, computerized simulating and shape-determining functions for establishing, on the basis of the reading and/or scanning function, the optimum or desired shape of the tooth replacement or unit, and a transmission arrangement using communications links comprising a computer and/or telecommunications link via which activation of a ordering and manufacturing system can be initiated for ordering and manufacturing all or part of the tooth replacement or unit.

In connection with the production of tooth replacements and units using the PROCERA® system, it has initially been proposed to manufacture the tooth replacements and units using titanium or ceramic. An object of an embodiment of the present invention is to make it possible to produce tooth replacements and units which have features and structures similar to or corresponding to the products made of metal or ceramic, but in which gold or gold alloy completely or partially replaces the metal (titanium) or the ceramic. In this way, it is possible, at least for some categories of patients, to make available an alternative to the metal and ceramic tooth replacements and units. An embodiment of this invention aims to solve this problem among others.

In one embodiment, it is advantageous that the basic function of the PROCERA® system can be retained in the production of the novel tooth replacements and units without having to undertake considerable reorganization or modification of the ordering and/or manufacturing procedures for the tooth replacements and units. An embodiment of the present invention also aims to solve this problem.

An embodiment of the present invention comprises a novel arrangement where, inter alia, a module system included in the ordering and manufacturing system is arranged to be capable, on the basis of the activation, of selecting, from among various manufacturing materials and tools, a manufacturing material in the form of gold and a tool in the form of a casting tool, and the module system, on the basis of information supplied to the ordering and manufacturing system, controls or determines the supply or amount of gold grains or gold material to the casting tool.

In further embodiments of the present invention, a module system is arranged to receive information on tooth type, patient age, etc., in connection with preparing for a complete production procedure for the tooth replacement or unit. The module system can comprise different modules for different preparation functions. The module system can also be arranged to receive information on the application or layout for possible inlaying of the gold or the gold material in the tooth replacement or the unit. The ordering and manufacturing system can also be arranged to inquire about or order from a gold supplier, via or by means of computer and/or telecommunications links, one or more tooth replacements or units. The scanning and/or reading function can operate with a mobile unit function, and an arrangement is designed to read and/or scan the treatment situation and transmit information regarding the request, order, etc., to a unit, for example a dental technician center, which serves several orderers and may be in communication with the highly automated ordering and manufacturing system. The scanning and/or scanning function can also be in contact with said central unit or the highly automated ordering and manufacturing system via a broadband connection. The casting tool can comprise two or more casting tool parts designed to be able to assume an assembled position in which the mold cavity is designed to correspond to the tooth replacement or unit in question. The scanning and/or reading function can operate with a digital camera designed to supply image information to the simulating and/or signal-generating unit for establishing measures to be taken in the treatment situation or for forwarding information to the central unit and/or the treatment and manufacturing system. The simulating and/or shape-determining function comprises or operates with a terminal by means of which questions can be sent and responses can be received via one or more links to the central unit and/or the ordering and manufacturing system. The module system can moreover comprise modules which are connected to a bus connection and can communicate with the scanning and/or scanning site and/or the central unit. Two or more of the modules can also communicate with one another if appropriate and can operate with an existing protocol on the bus connection.

That which can principally be regarded as characterizing the tooth replacement or unit according to an embodiment of the present invention is that it is made completely or partially of cast gold or cast gold alloy.

By means of what is proposed above, in one embodiment, it is possible to create tooth replacements and units in cast gold (gold alloy) using the basic functions of the PROCERA® system. Reference may be made here to the ceramic crowns produced by means of this system, and also to the titanium-based casting method and KYVETT. The conventional structures with dentist and dental technician functions can be used in connection with the known PROCERA® system, and treatment and manufacturing methods and auxiliaries known per se can be used in the latter.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements various features of specific embodiments of the invention will now be described with reference to the drawing. The drawing and the associated descriptions are provided to illustrate embodiments of the invention and not to limit the scope of the invention.

FIG. 1 shows a block diagram of the highly automated PROCERA® system connected to a dental technician center and dentist-based user sites, and

FIG. 2 shows a diagrammatic vertical view of a casting tool with mold cavity for a tooth replacement or unit, and where gold particles or gold material can be applied.

### DETAILED DESCRIPTION OF THE PREFERRED EMBODIMENTS

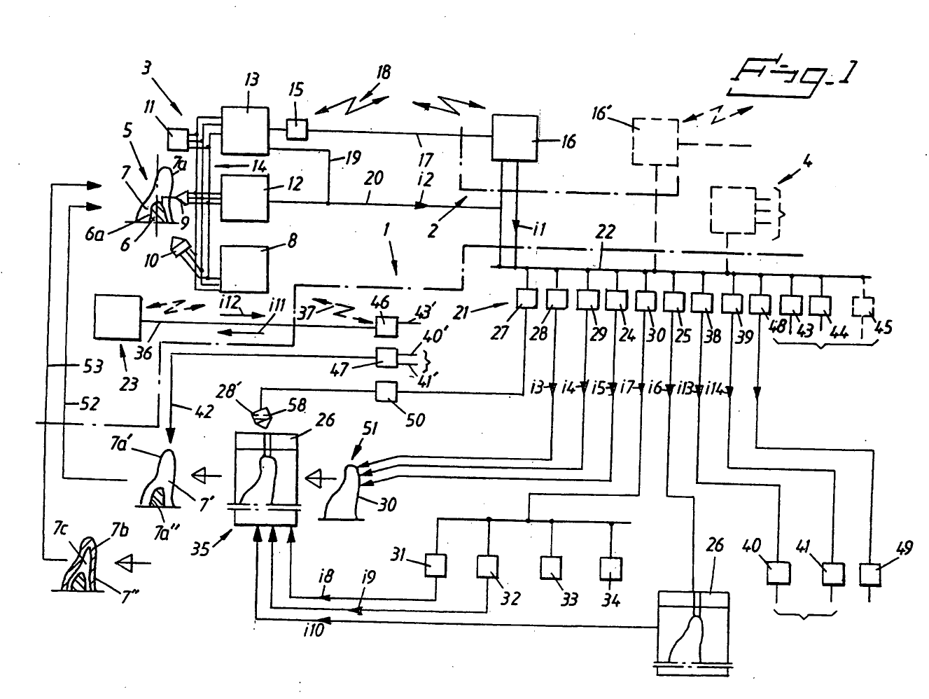

In FIG. 1, a highly automated ordering and manufacturing system for tooth replacements and units is designated by reference number 1. The system 1 can use of a number of dental technician-based centers, which are identified by the reference number 2 and which in turn serve practicing dentists, dental surgeons, radiology specialists, etc. 3, 4. A treatment situation is represented symbolically or diagrammatically in FIG. 1 by reference number 5. The treatment situation can concern a tooth stump 6 whose outer shape 6a can be scanned or read in a manner known per se. A tooth replacement, for example a crown 7, can be applied to the tooth stump 6. The structure, status, etc., of the tooth stump 6 can be determined with the aid of identification equipment 8, which can be configured using computerized support means known per se. Simulation functions can also be provided by the unit 8. In these simulation functions, the tooth stump onlay 7 is assigned an optimal or desired shape in a manner known per se.

The reading of the actual tooth stump 6 can be carried out in a manner known per se, for example by means of a scanning function with direct contact with the outer surface 6a. Alternatively, the scanning of the surface can be carried out without contact, for example by a laser beam, optical beam, etc. This scanning too is known per se, and means for performing the contactless scanning are designated by 10. The reading or scanning can also be done with the aid of camera equipment 11 of a type known per se. Thus, for example, a digital camera or digital cameras can be used to identify the outer shape 6a in question. The outer surface of the crown or the like simulated or calculated by the unit 8 is indicated by 7a. The image information from the camera 11 can be supplied to the unit 8 which effects simulation of or assesses the treatment situation as such.

The scanning or the calculated measures can be transmitted to a unit 12 which converts the scanned situation to digital signals in a manner known per se. A terminal 13 is also included which can be a question and response terminal by means of which questions can be fed to the center 2 or system 1 and responses can be obtained from the center or system. A bus connection between the units 8, 12 and 13 is indicated by 14. An adapter unit between the unit 13 and the center 2 is indicated by 15. The adapter unit 15 and a unit 16 at the center can be coupled via a broadband connection 17, a radio connection 18, etc. Corresponding connections can be made in the system 1, although in the present case only a cable connection, for example a broadband connection, has been shown in FIG. 1 by reference number 19. The unit 12 can be in communication with the system 1 and the center 2 via connection 20. Corresponding arrangements can be provided for other user sites 4, which can be connected in a corresponding or similar way to the center 2 and the system 1.

The system 1 comprises a module system with a number of modules (as described below) which are connected to a bus connection 22. The modules control functions in the system 1 in connection with the production of tooth replacements and units made of cast gold or cast gold alloy. A fourth party is involved in the described context. This fourth party is a gold dealer or gold supplier indicated by reference number 23. In connection with the manufacture of tooth replacements and units, the system 1 can make inquiries about and order gold supplies from the gold dealer 23. Activation of the ordering and manufacturing system 1 can be initiated from the center by means of order information i1 or alternatively from a user site by means of information i2. The order information concerns the ordering and manufacturing of all or part of the tooth replacement 6 or unit. Upon said activation, the module system 21 can select manufacturing material in the form of gold or gold material and a tool in the form of a casting tool. The module system is also set up to control or determine the supply or amount of gold grains or gold material to the casting tool, as a function of the information i1, i2 sent to the system 1. Thus, the system includes a module 24 for ordering manufacturing material and a module 25 for ordering a tool, i.e. a casting tool 26. A module 27 determines or controls the supply or amount of grains of gold or gold material 28 to the selected casting tool 26. A module 28 receives and transmits information i3 on tooth type (e.g. front tooth). A module 29 transmits information i4 on the shape of the tooth replacement or unit 30 which is being manufactured. The information from the module 24 is indicated by i5 and the information from the module 25 is indicated by i6. The arrangement also includes a module 30 which, by means of information i7, selects a manufacturing method 31 which is singled out by a subsidiary module 31. Examples of production methods which may be mentioned include milling, grinding, spark erosion, etc. A subsidiary module 32 thus controls the spark erosion function. Further subsidiary modules 33 and 34 can be provided for, respectively, grinding and polishing, and so forth. The selected functions from the modules 31, 32 and 25 cause information to be sent to an order site 35, and the signals for this are indicated by i8, i9 and i10. The connection to the gold dealer 23 is indicated by 36 and can be a communications link. Alternatively, a wireless link 37 can be used. The information transfer between the system 1 and the gold dealer is illustrated by i11 and i12.

Further modules 38 and 39 are provided for the function of inlaying and positioning the gold or gold alloy in other material from which the dental crown or unit can be made. Thus, for example, it may be desirable for only the outer layer of the tooth replacement or unit to be coated with gold. The units control by means of information i3 and i14 subsidiary modules 40, 41 which can be coupled to the procedure at the production site 35 in a manner not shown. Said inlaying can be carried out based on percentage calculations, for example for determining costs. The inlaying and percentages are symbolized by 42 in FIG. 1. Modules 43, 44 and 45 can relate to general data in the system, economic running, etc. These functions are used to control the economic functions in the system indicated overall in FIG. 1 in a manner known per se. Thus, for example, the module 43 deals with queries to the gold dealer, cf. 43′, and via a module 46. The inlaying and percentage indication from the modules 40 and 41 are supplied to a module 47 via connections 40′ and 41′, respectively. With the aid of the module 44, the use of the system 1 is debited from the users 3 and the center 2. The modules 48 and 49 can be seen as reserve modules. The supply of material 28 from the module 27 is controlled via a subsidiary module 50. By means of the construction, the product 30 that is to be produced can be determined inter alia with the aid of information i3, i4 and i5. A tool 26 can be selected and the information i3, i4 and i5 can be transmitted to the production site 35.

In the illustrative embodiment according to FIG. 1, a first tooth replacement or unit 7′ can be obtained, which tooth replacement or unit has an outer shape 7a′ and an inner shape 7a″. The outer shape can be obtained in the casting tool 26. This applies also to the inner shape 7a″, which however can alternatively be obtained by machining, for example spark erosion. An alternative embodiment is shown by 7″, which embodiment has been produced with an outer layer 7b of cast gold or cast gold alloy applied on another material 7c, for example titanium, which can also be cast or milled from a blank. The outer and inner shapes correspond to what has been stated for the embodiment according to 7′. The finished product is transferred to the user site 3 via a connection indicated symbolically by 52 and 53.

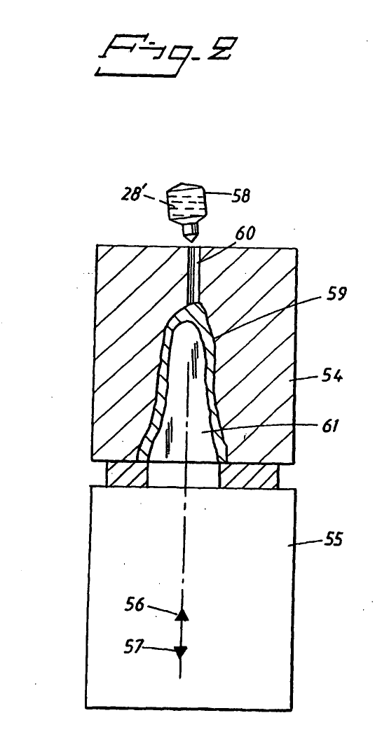

FIG. 2 shows the casting tool in more detail. The casting tool comprises an upper part 54 and a lower part 55. The parts can be acted upon in directions 56 and 57. In an alternative to this, one part 54 or 55 is stationary relative to the other part. In another alternative, both parts are movable in the directions 56 and 57. The container for the gold or gold alloy or gold material 28′ is applied in a container 58. The tool parts 54 and 55 when assembled form a mold cavity 59 which corresponds to the desired tooth replacement or unit 7 (see FIG. 1). The upper part comprises a channel 60 extending from the outside of the casting tool to the mold cavity. The gold material (grains of gold) in question is applied via this channel so that the mold cavity is filled. The lower part is provided with a stamp 61. The parts are pressed together with high pressure so that the casting function is obtained in a manner known per se.

Although the foregoing systems and methods have been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. While certain embodiments of the inventions have been described, these embodiments have been presented by way of example only, and are not intended to limit the scope of the inventions. Indeed, the novel methods and systems described herein may be embodied in a variety of other forms without departing from the spirit thereof

1. An automated ordering and manufacturing system for producing a tooth replacement part from gold, comprising:
a measurement device configured to determine a shape of a treatment site;
a simulation device configured to generate a desired shape of the tooth replacement part based, at least in part, upon measurements received from the measurement device;
a communications link configured to receive information to initiate ordering and manufacturing of the tooth replacement part, and
a module system configured to, on the basis of a activation signal transmitted by the communications link, of selecting, from a plurality of manufacturing materials and tools, said plurality of manufacturing materials and tools, including at least a manufacturing material in the form of gold or gold material and a tool in the form of a casting tool and, the module system being further configured, on the basis of information supplied to the ordering and manufacturing system through the communications link, to determine an amount of gold material to be supplied to the casting tool.

2. The system as claim 1, wherein in the module system is configured to receive and use information on tooth type to complete a production procedure for the tooth replacement part.

3. The system as claim 2, wherein in the module system is configured to receive and use information on the patient's age to complete a production procedure for the tooth replacement part.

4. The system as in claim 1, wherein the module system is configured to receive and transmit information concerning a position of the gold material in the tooth replacement unit.

5. The system as in claim 1, wherein the ordering and manufacturing system is configured to receive or send information regarding the tooth replacement part to a gold supplier.

6. The system as in claim 1, wherein the measurement device is configured to operate within a mobile unit and the system is configured to transfer information from the measurement device to a remote dental technician unit, which is configured to receive several orders.

7. The system as in claim 6, further comprising a broadband connection between the mobile unit and the remote dental technician unit.

8. The system as in claim 1, wherein the measurement device comprise a terminal, which includes means for sending questions and receiving responses to/from the ordering and manufacturing system.

9. The system as in claim 1, wherein the casting tool comprises at least two casting tool parts configured to be able to assume an assembled position to define a mold cavity that is designed for the tooth replacement part.

10. The system as in claim 1, wherein the scanning the measurement device comprises a digital camera.

11. The system as in claim 1, wherein the module system comprises a plurality of modules which are linked by a bus connection and can communicate with the measurement device and each other.

12. The system of claim 1, wherein the system is the PROCERA® type

13. The system of claim 1, wherein the tooth replace part comprises a dental crown.

14. A tooth replacement part that is made at least partially of a gold material.

15. The tooth replacement part as in claim 14, wherein the part is made completely of gold material.

16. The tooth replacement part as in claim 14, wherein the gold material is cast gold.

17. The tooth replacement part as in claim 14, wherein the gold material is cast gold alloy.
